(19) United States
(12) Patent Application Publication
(10) Pub. No.: US 2026/0158815 A1
(43) Pub. Date: Jun. 11, 2026

(54) IMPROVED GEOMETRICAL INSTRUMENT

(71) Applicants: ARVIND KUMAR, Gurugram (IN); RIMJHIM SHARMA, Gurugram (IN)

(72) Inventor: ARVIND KUMAR, Gurugram (IN)

(21) Appl. No.: 18/707,550

(22) PCT Filed: Mar. 25, 2022
(86) PCT No.: PCT/IN2022/050301

§ 371 Date: May 3, 2024

(30) Foreign Application Priority Data
Nov. 3, 2021 (IN) 202111050643

(51) Int. Cl. B43L 13/00

(52) U.S. Cl. CPC B43L 13/001

(57) ABSTRACT

The present invention discloses an instrument for solving problems of geometry, including a primary unit, a secondary unit and a tab set. The primary unit includes a plurality of outer edges and an inner edge defining a hollow space. A bar defines a gap with respect to a solid edge of the secondary unit The tab set is slidably disposed within the gap. A first section of the tab set includes one or more holes to enable a user to draw on a drawing surface. A second section of the tab set slides over the solid edge. The inner edge of the primary unit is configured to sit flush over a peripheral edge of the secondary unit.

### FIELD OF INVENTION

The present invention relates to a mathematical instrument and more particularly, related to an instrument for geometrically solving mathematical problems.

### BACKGROUND

Conventional instruments used to solve problems of geometry include a ruler/scale, compass, divider, set squares, protractor (180° or 360°), etc. contained inside a box (commonly known as Geometry box). Each of the said conventional instruments includes a distinct and unique function, usually separate from others. The end user has to constantly switch between these instruments while solving a geometric problem. The constant switching tends to be laborious for the end user. Further, due to constant switching of instruments, risk of high margin of compounding errors creeping into the solution increases thereby giving inaccurate and inconsistent results.

Further, some of the conventional instruments (like the compass) requires a leverage/anchor point to function. This often leaves undesirable marks/holes on the drawing surface, again giving inaccurate and inconsistent results. More often than not, the ends of the compass (the metallic tip and the pencil tip) are non-colinear and non-coplanar leading to inaccurate results. In addition, the ends forever compete to dislodge the other from the drawing surface, especially at smaller radii.

The conventional instruments are not always compatible with each other (with respect to the drawing edge and the measuring edge) and the pencil (or equivalent drawing means). More often than not, jitters in pencil movement leads to compounding of errors while solving geometric problems.

Therefore, there arises a need for an instrument for solving geometrical problems with greater accuracy and efficiency and further overcomes the associated drawbacks of conventional instruments.

### SUMMARY

The present invention relates to an instrument for solving problems of geometry. The instrument including a primary unit, a secondary unit and a tab set. The primary unit includes a plurality of outer edges and an inner edge defining a hollow space. The secondary unit is rotatably coupled to the hollow space of the primary unit. The secondary unit includes a peripheral edge, a bar, and a solid edge. The bar defines a gap with respect to the solid edge. The tab set is slidably disposed within the gap of the secondary unit. The tab set includes a first section, a second section and a third section. The first section includes one or more holes to enable a user to draw on a drawing surface. The second section slides over the solid edge of the secondary unit. The third section is slidably coupled to the bar of the secondary unit. The inner edge of the primary unit is configured to sit flush over the peripheral edge of the secondary unit.

The foregoing features and other features as well as the advantages of the invention will become more apparent from the following detailed description, which proceeds with reference to the accompanying figures.

### BRIEF DESCRIPTION OF DRAWINGS

The summary above, as well as the following detailed description of illustrative embodiments, is better understood when read in conjunction with the apportioned drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale.

FIG. 1 depicts an instrument 100 in accordance with an embodiment of the present invention.

FIG. 2 depicts a primary unit 110 in accordance with an embodiment of the present invention.

FIG. 3 depicts a secondary unit 130 in accordance with an embodiment of the present invention.

FIG. 4 depicts a tab set 150 in accordance with an embodiment of the present invention.

### DETAILED DESCRIPTION OF THE DRAWINGS

Prior to describing the invention in detail, definitions of certain words or phrases used throughout this patent document will be defined: the terms “include” and “comprise”, as well as derivatives thereof, mean inclusion without limitation; the term “or” is inclusive, meaning and/or; the phrases “coupled with” and “associated therewith”, as well as derivatives thereof, may mean to include, be included within, interconnect with, contain, be contained within, connect to or with, couple to or with, be communicable with, cooperate with, interleave, juxtapose, be proximate to, be bound to or with, have a property of, or the like; Definitions of certain words and phrases are provided throughout this patent document, and those of ordinary skill in the art will understand that such definitions apply in many, if not most, instances to prior as well as future uses of such defined words and phrases.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Particular embodiments of the present disclosure are described herein below with reference to the accompanying drawings, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

A line may be defined as a straight and/or curve line with indefinite length (a line with no end points or a ray) or definite length (a line segment).

A polygon may be defined as a closed or open structure made up of one or more lines each having at least one angular relation with an adjacent line.

A drawing surface may be defined as a two-dimensional plane/surface.

A scale marking may be defined as a series of graduation marking corresponding to one of a length, angle, direction, etc. The scale marking may be associated with relevant scientific units (labels) including but not limited to centimeter, millimeter, degree, etc. The graduation marking may be closer to the drawing surface and the labels may be farthest from the drawing surface to minimize parallax errors. Other ways of marking to increase readability are within the scope of the teachings of the present invention.

The scale marking may also be provided with Vernier section having appropriate least count to get an accuracy of at least two decimal places. The scale marking may be etched or printed. In an embodiment, the scale markings are printed in black color.

The mathematical terminologies used in the present invention corresponds to their respective definition known in the art unless explicitly defined otherwise.

In accordance with the present disclosure, an instrument for solving problems of geometry is disclosed. Problems of geometry may include but not limited to working with cartesian coordinate system, polar coordinate system, academic mathematics, engineering drawings, civil engineering (with bubble inclinometer), astronomical data, etc. In addition to linear drawing/measurement, the instrument of the present invention can measure angle and draw arc, circle, chord, sector and segment, etc. The instrument of the present invention alone can replace the functionality of multiple geometrical instruments thereby minimizing errors. The instrument of the present invention provides consistent reproduction of geometric solution without any loss in accuracy. The instrument of the present invention can act as a geometric box kit for every student, draftsman, technician, artisan, Goldman, surveyor, navigator, movement controller and/or security personnel.

The instrument of the present invention enables accurate drawing/measurements without any need of a physical anchor (usually a hole) on the drawing surface. This maintains the integrity of the drawing surface. Vernier features on both linear and angular scale enable highly accurate drawings (up to two decimal places). The instrument of the present invention is a very simple and easy to use instrument which can be easily adopted by a user. The instrument is also very durable and therefore can be used for many years without sacrificing the functionality of the instrument. The instrument can easily be scaled (up or down) to fit user requirements.

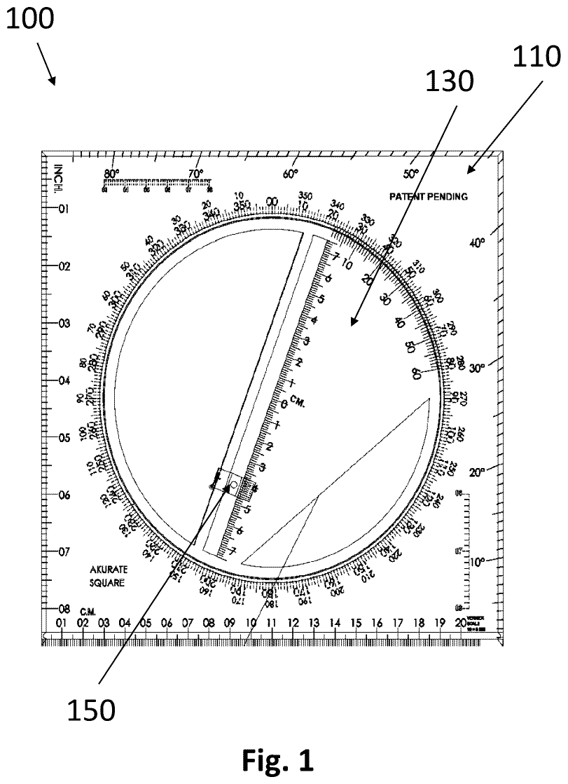

FIG. 1 illustrates an exemplary embodiment of the instrument 100 of the present invention. The instrument 100 includes a plurality of components including but not limited to a primary unit 110, a secondary unit 130, a tab set 150, etc. The said components of the instrument 100 may be used alone or in combination with each other as required by the user.

The instrument 100 may be made of a thermal resistant material (with achievable minimum resistance) including but not limited to acrylic, plastic, glass, metallic alloys, high/low density polymer or a combination thereof. The instrument 100 may be rigid, flexible, transparent, translucent, opaque or a combination thereof. In an embodiment, the instrument 100 is made of transparent high-density polymer which is hard, inflexible and scratch resistant. In yet another embodiment, the instrument 100 is made of a translucent high-density polymer which is flexible, unbreakable and scratch resistant. In yet another embodiment, the instrument 100 is made of a metal like stainless steel. The instrument 100 may have enhanced durability thereby improving its usability. Further details of the primary unit 110, the secondary unit 130, and the tab set 150 are provided below.

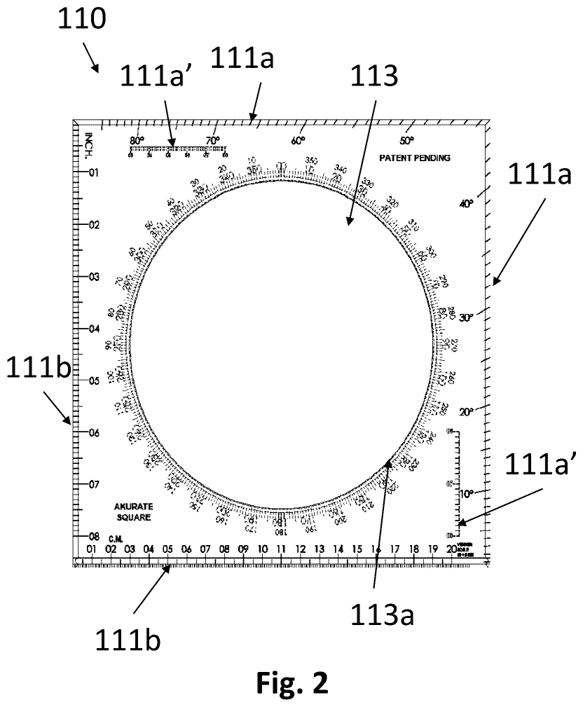

FIG. 2 illustrates the primary unit 110 of the instrument 100. The primary unit 110 may have any shape including but not limited to square, rectangle, pentagon, hexagon, etc. The primary unit 110 may be have a thickness ranging from 1 mm to 2 mm. The primary unit 110 may have a size which may be scaled up or down based on the requirements of the user. In an embodiment, the primary unit 110 is square shaped with 22 cm long edges and is 1.7 mm thick.

The primary unit 110 may include a plurality of outer edges 111a, 111b based upon its shape. The plurality of outer edges 111a, 111b of the primary unit 110 may each include a plurality of markings corresponding to different units of length and/or angle. In an embodiment, as depicted in FIG. 2, two adjacent outer edges 111a of the primary unit 110 include angular scale markings with corresponding vernier sections 111a′ and the remaining two outer edges 111b include a linear scale in different units (centimetres and inches) with corresponding vernier sections (not shown).

The plurality of outer edges 111a, 111b of the primary unit 110 may align with a tip of the plurality of markings (line marks) to minimize parallax error. The plurality of outer edges 111a, 111b, at a face of the primary unit 110 facing away from the drawing surface, may be smoothed by angular trimming to improve readability of the plurality of markings. In an exemplary embodiment, the outer edges 111a, 111b of the primary unit 110 is smoothed with angular trimming of 0.3 mm.

The primary unit 110 may include a hollow space 113 to accommodate the secondary unit 130. Other functionally equivalent means to couple the primary unit 110 to the secondary unit 130 is within the scope of the teachings of the present invention. In an exemplary embodiment, the hollow space 113 is provided at a centre of the primary unit 110. The primary unit 110 may include an inner edge 113a defining the hollow space 113. In an embodiment, the inner edge 113a may be angled (beveled) with respect to the drawing surface for example, by 45 degrees. In other words, the inner edge 113a may be beveled by an inclination (broader base and narrower top) or a dovetail joint between the primary unit 110 and the secondary unit 130 (further described below).

As depicted in FIG. 1, the inner edge 113a of the primary unit 110 may be disposed on top of the secondary unit 130 such that the secondary unit 130 resides between a drawing surface and the inner edge 113a of the primary unit 110.

Similar to the outer edges 111a, 111b, the inner edge 113a of the primary unit 110 may be provided with the plurality of markings corresponding to different angle. In an embodiment, shown in FIG. 2, the inner edge 113a of the primary unit 110 is provided with a clockwise as well as an anticlockwise angular scale; each ranging from 0-360 degrees.

In addition to the scale markings provided at the outer edges 111a, 111b and the inner edges 113a, either face of the primary unit 110 may include one or more markings corresponding to different units of length and/or angle. Additionally and/or optionally, one or more mathematical conversion rate/formula may also be provided over the primary unit 110 for easy reference to the user.

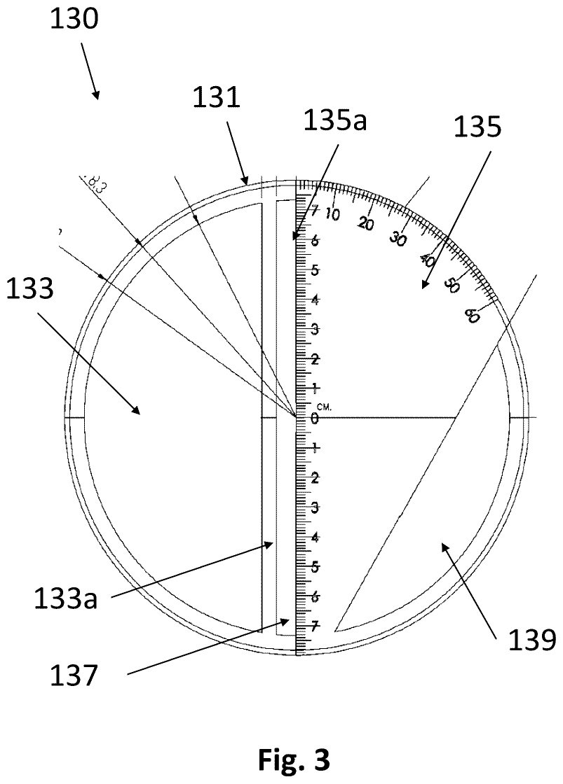

FIG. 3 illustrates the secondary unit 130 of the instrument 100. The secondary unit 130 may be rotatably coupled to the primary unit 110. The secondary unit 130 may have a shape corresponding to the shape of the hollow space 113 of the primary unit 110. In an exemplary embodiment, as shown in FIG. 3, the secondary unit 130 is ring shaped with a diameter of 16.7 mm and is 1.7 mm thick.

The secondary unit 130 may include a peripheral edge 131 corresponding to the inner edge 113a of the primary unit 110 such that the inner edge 113a may be configured to sit flush over the peripheral edge 131 i.e., the secondary unit 130 may not protrude beyond the primary unit 110. The primary unit 110 and the secondary unit 130 may be completely coplanar at least with respect to the drawing surface. In other words, the instrument 100 may have a uniform refractive index throughout. The said arrangement enables the user to rotate (exclusively) the primary unit 110 with respect to the secondary unit 130 and vice versa. In other words, the user may rotate either the primary unit 110 or the secondary unit 130 at a time with respect to the drawing surface. The peripheral edge 131 and the inner edge 113a acts as a guide to each other while rotating either of the primary unit 110 or the secondary unit 130 respectively.

Similar to the primary unit 110, the peripheral edge 131 of the secondary unit 130 may include one or more markings corresponding to different units of length and/or angle. In an embodiment, as shown in FIG. 3, the peripheral edge 131 include a vernier scale corresponding to the scale markings of the inner edge 113a of the primary unit 110.

The secondary unit 130 may be partially or completely hollow. In an embodiment, as shown in FIG. 3, the secondary unit 130 is partially hollow such that a diameter of the secondary unit 130 bisects the secondary unit 130 into a ring portion 133 and a solid portion 135. The ring portion 133 may resemble a half ring while the solid portion 135 may resemble a solid semicircle. In other words, the secondary unit 130 may be made up of the ring portion 133 and the solid portion 135. The diameter of the secondary unit 130 may overlap/align with a solid edge 135a of the solid portion 135. The solid edge 135a may be provided with one or more linear scale marking. Alternatively, the solid edge 135a of the solid portion 135 may be disposed away from but parallel to the diameter of the secondary unit 130.

The ring portion 133 may include a bar 133a parallel to the solid edge 135a of the solid portion 135. The bar 133a may define a gap 137 with respect to the solid edge 135a. As depicted in FIG. 1, the tab set 150 may be slidably coupled to the gap 137. In an exemplary embodiment, the gap 137 includes a width of 6 mm.

Additionally and/or optionally, the solid portion 135 may have a rotating means 139 to enable the user to apply a rotational force to the secondary unit 130. In an embodiment, as shown in FIG. 3, the rotating means 139 is a cutout provided within the solid portion 135 of the secondary unit 130. Other functionally equivalent means to enable the user to rotate the secondary unit 130 and/or the primary unit 110 with respect to each other are within the scope of the teachings of the present invention.

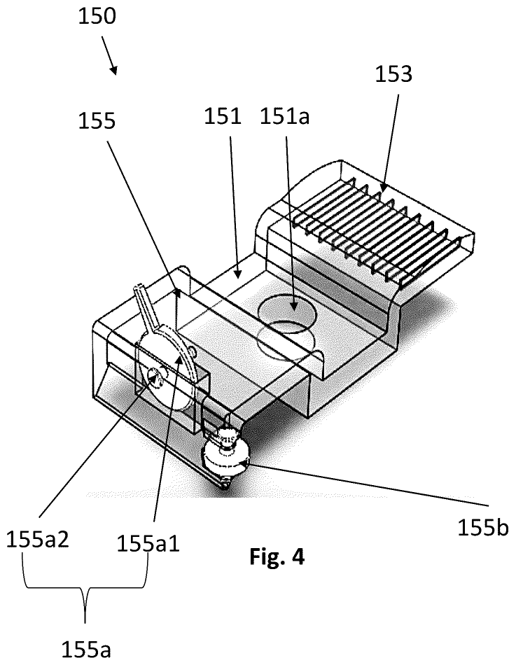

FIG. 4 depicts the tab set 150 of the instrument 100. The tab set 150 may be slidably disposed within the gap 137 of the secondary unit 130 (shown in FIG. 1). The tab set 150 may slide along an entire length of the bar 133a of the secondary unit 130. Other functionally equivalent structure instead of the tab set 150 is within the scope of the teachings of the present invention.

The tab set 150 may include a first section 151, a second section 153 and a third section 155. The first section 151 of the tab set 150 may be disposed within the gap 137 of the secondary unit 130 such that the second section 153 slides over the solid edge 135a. The third section 155 may be slidably coupled to the bar 133a of the secondary unit 130. The first section 151 may contact the drawing surface when using the instrument 100. The first section 151 may include one or more holes 151a to enable the user to draw (via a pencil or other equivalent means) on the drawing surface through the first section 151. In an embodiment, as shown in FIG. 4, the first section 151 includes one hole 151a at the centre. The hole 151a reduces pencil (or equivalent means) jitter during using the instrument 100 thereby providing accurate solutions to the geometric problems.

The second section 153 of the tab set 150 may include a convex lens-like structure which enables easy (magnified) readability of the scale markings of the solid edge 135a of the secondary unit 130. The second section 153 may also include a vernier scale corresponding to the scale markings of the solid edge 135a of the secondary unit 130.

The third section 155 may include a locking mechanism 155a and a tuning mechanism 155b. The locking mechanism 155a may restrict the movement of the tab set 150 with respect to the secondary unit 130. In an embodiment, as shown in FIG. 4, the locking mechanism 155a includes a lever 155a1 and a pin 1555a2. The pin 155a2 may have a lateral movement upon actuating the lever 155a1. In other words, the pin 155a2 may have a lock position and an unlock position. The lever 155a1 may be used to change the pin 155a2 from the unlock position to the lock position and vice versa. In the lock position, the pin 155a2 may press on the bar 133a thereby restricting movement of the tab set 150 with respect to the secondary unit 130. In the unlock position, the pin 155a2 may not press on the bar 133a thereby providing (sliding) movement of the tab set 150 over the bar 133a. Other functionally equivalent structure/implementation of the locking mechanism 155a is within the scope of the teaching of the present invention.

The tuning mechanism 155b of the tab set 150 may be operatively coupled to the bar 133a of the secondary unit 130. The tuning mechanism 155b may enable the user to fine tune a position of the tab set 150 with respect to the bar 133a when the pin 155a2 is in locked position and/or unlocked position. In an embodiment, as shown in FIG. 4, the tuning mechanism 155b includes a wheel. The tuning mechanism 155b is operatively coupled to the bar 133a such that each complete revolution of the tuning mechanism 155b translates to a pre-defined change in position of the tab set 150 with respect to the bar 133a. The change in position of the tab set 150 may have a direction corresponding to a direction of the revolution of the tuning mechanism 155b. In an exemplary embodiment, one complete revolution of the tuning mechanism 155b provides a predefined unit shift in position of the tab set 150 with respect to the bar 133a of the secondary unit 130. Other functionally equivalent structure/implementation of the tuning mechanism 155b is within the scope of the teaching of the present invention.

The scope of the invention is only limited by the appended patent claims. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

1. An instrument for solving problems of geometry, the instrument comprising:
a primary unit including a plurality of outer edges and an inner edge defining a hollow space;
a secondary unit rotatably coupled to the hollow space of the primary unit, the secondary unit including a ring portion and a solid portion defining a solid edge that separates the solid portion from the ring portion, the solid edge being parallel to a diameter of the secondary unit.
wherein the ring portion includes a bar defining gap with respect to the solid edge; and
a tab set slidably disposed within the gap of the secondary unit, the tab set including, a second section having a vernier scale corresponding to scale markings of the solid edge;
wherein the inner edge of the primary unit is configured to sit flush over a peripheral edge of the secondary unit.

2. The instrument as claimed in claim 1, wherein each of the plurality of outer edges of the primary unit include a plurality of markings corresponding to different units of length or angle.

3. The instrument as claimed in claim 1, wherein the secondary unit is coupled to the primary unit via a dovetail joint.

4. The instrument as claimed in claim 1, wherein the secondary unit resides between a drawing surface and the inner edge of the primary unit.

5. The instrument as claimed in claim 1, wherein the inner edge of the primary unit is provided with a clockwise as well as an anticlockwise angular scale.

6. (canceled)

7. The instrument as claimed in claim 1, wherein the solid portion includes a rotating means.

8. The instrument as claimed in claim 1, wherein the second section of the tab set includes a convex lens-like structure.

9. The instrument as claimed in claim 1, wherein the third section includes a tuning mechanism to enable the user to fine tune a position of the tab set with respect to the bar.

10. The instrument as claimed in claim 1, wherein the third section includes a locking mechanism to restrict the movement of the tab set with respect to the secondary unit.
